(19) United States
(12) Patent Application Publication
(10) Pub. No.: US 2006/0070091 A1
(43) Pub. Date: Mar. 30, 2006

(54) Disk drive provided with tray for preventing adhesion of grease

(76) Inventor: Takeshi Makino, Fukui (JP)

Correspondence Address: WENDEROTH, LIND & PONACK, L.L.P., 2033 K STREET N. W., SUITE 800, WASHINGTON, DC, 20006-1021, US

(21) Appl. No.: 11/235,339

(22) Filed: Sep. 27, 2005

(30) Foreign Application Priority Data
Sep. 29, 2004 (JP) 2004-282914

(51) Int. Cl. G11B 17/04; G11B 17/03; G11B 33/02

(52) U.S. Cl. 720/601

(57) ABSTRACT

In order to provide a disk drive in which grease applied to a guide groove provided on the both sides of a back surface of a tray does not adhere to a hand, wide opening grooves are respectively formed on the both sides of the back surface of the tray, a guide groove to which at least a boss protruded from a drive body chassis is fitted with play so as to be freely slidable is formed on a bottom part of the wide opening groove and grease is applied to the guide groove.

### BACKGROUND OF THE INVENTION

1. Field of the Invention

The present invention relates to a disk drive with a tray, which sets a disk thereon and can be taken out and in from a drive body.

2. Related Art

In a disk drive comprising a tray for placing a disk such as a CD and a DVD to carry the same in and out a drive body of the device, the tray is driven to move back and forth by means of a motor between a place for changing the disk and a place for housing the disk. FIGS. 4 and 5 show a tray driving mechanism in such a conventional disk drive. In FIGS. 4 and 5, straight guide grooves 3, 3 are provided parallel on the both sides of a back surface of a tray 1. Bosses 5, 5 rising from a chassis of a drive body are fitted into the guide grooves 3, 3 with play. A rack 7 is provided parallel to the guide grooves 3, 3 on one end of the back surface of the tray 1. The rack 7 is engaged with a gear 6 driven by means of a motor. Thus, binding the guide grooves 3, 3 with the right and left bosses 5, 5 allows the tray 1 to slide by means of the motor between the place for changing the disk and the place for housing the disk.

For the purpose of a smooth slide of the tray without great frictonal drag, grease is applied to the guide grooves 3, 3. FIG. 5 shows the boss 5 fitted to the guide groove 3 with play in an enlarged view, and a black-painted place denotes grease 8. The grease 8 is applied to bottom and inner surfaces of the guide groove 3 to reduce friction between the guide groove 3 and the boss 5 as a lubricant, so that smooth sliding movement is achieved.

On the other hand, a door 9 mounted to a front opening from which the tray 2 goes back and forth is urged by a spring so as to be pressed from the back to be rotated for opening when the tray 11 is protruded from the opening and so as to be dosed at the same time as the tray 11 goes back. An upper edge of the door 9 is in contact with a back surface 2 of the tray at all times when the tray 1 is carried out to protrude from the front opening, as shown in FIG. 6. This causes a problem such that the grease 8 adhered to lower edges of the both side surfaces of the guide groove 3 would be adhered to a user's hand or the door 9, and thereby, dirty the same.

A disk drive comprising a tray driving mechanism having such a structure is disclosed in JP-A-2003-196907, JP-A-2002-288914, JP-A-2004-145981 and JP-A-2003-317357, for example. The disk drives disclosed in the above all have the above mentioned problem of adhesion of grease.

### SUMMARY OF THE INVENTION

In view of such a problem in the prior art, an object of the invention is to provide a disk drive having a structure in which grease applied to a guide groove does not come out from a back surface of a tray.

For the purpose of the above, a disk drive according to the invention comprises a tray for setting and carrying in and out a disk, wherein wide opening grooves are respectively formed on both sides of a back surface of the tray, a guide groove to which at least a boss protruded from a drive body chassis is fitted with play so as to be freely slidable is formed on a bottom part of the wide opening groove and grease is applied to the guide groove. Such a structure allows the wide opening groove to exist between a lower edge of the side surface of the guide groove and a lower end surface of the tray, so that the grease applied to the guide groove is collected at the lower edge of the side surface of the guide groove, and thereby, does not adhere to the lower end surface of the tray.

It is preferable that a bottom surface of the wide opening groove is a horizontal surface since the grease is collected at the lower edge of the side surface of the guide groove and difficult to flow downward. Further, it is preferable that a bottom surface of the wide opening groove is an inclined surface whose both sides are higher, that is, the bottom surface of the wide opening groove makes an acute angle with a side surface of the guide groove in section, since the grease is more difficult to flow downward. An inner surface of the wide opening groove is not necessarily vertical to a bottom of the groove. An inclined inner surface may be formed. The kind of grease is not limited, of course.

Moreover, it may be possible that the boss protruded from the drive body chassis forms a pair projected with a predetermined space, the two guide grooves are formed to which the pair of bosses are respectively fitted with play and a guide piece is formed between the both guide grooves so as to be sandwiched between the both bosses. Such a structure allows the boss to be stronger. In addition, arranging that one of the pair of guide grooves be formed deeper than the other so that only a top end of one boss would be freely slidable on and contact with a shallower bottom surface of the guide groove and that grease be not applied to a deeper bottom surface of the guide groove allows to increase the strength of the boss and also reduce friction.

According to the disk drive of the invention, the guide grooves on the both sides of the back surface are formed on the bottom of the wide opening grooves, so that grease applied to the guide grooves cannot flow from the guide grooves onto the back surface of a tray. That is to say, the grease cannot come out from the back surface of the tray even when the grease flows down to a lower edge of inner surfaces of the guide groove since the grease is located on the bottom of the wide opening groove, so that the grease is not adhered to a user's hand. The grease, of course, does not flow along the side surface of the wide opening groove to come out from the back surface of the tray. It is not necessary to apply grease so much as to come out from the back surface.

### BRIEF DESCRIPTION OF THE DRAWING

FIG. 1 is a plan view showing a disk drive provided with a tray for preventing adhesion of grease in accordance with an embodiment of the invention;

FIG. 2 is a vertical section view showing a guide groove formed on a back surface of the tray;

FIG. 3 is a vertical section view showing a guide groove in another mode;

FIG. 4 is a vertical section view showing a guide groove in further another mode;

FIG. 5 is a perspective plan view showing the shape of a bottom surface of a tray of a conventional disk drive;

FIG. 6 is a vertical section view showing a guide groove formed on a back surface of the tray; and

FIG. 7 is a side view showing the tray carried out.

### DETAILED DESCRIPTION OF PREFERRED EMBODIMENT

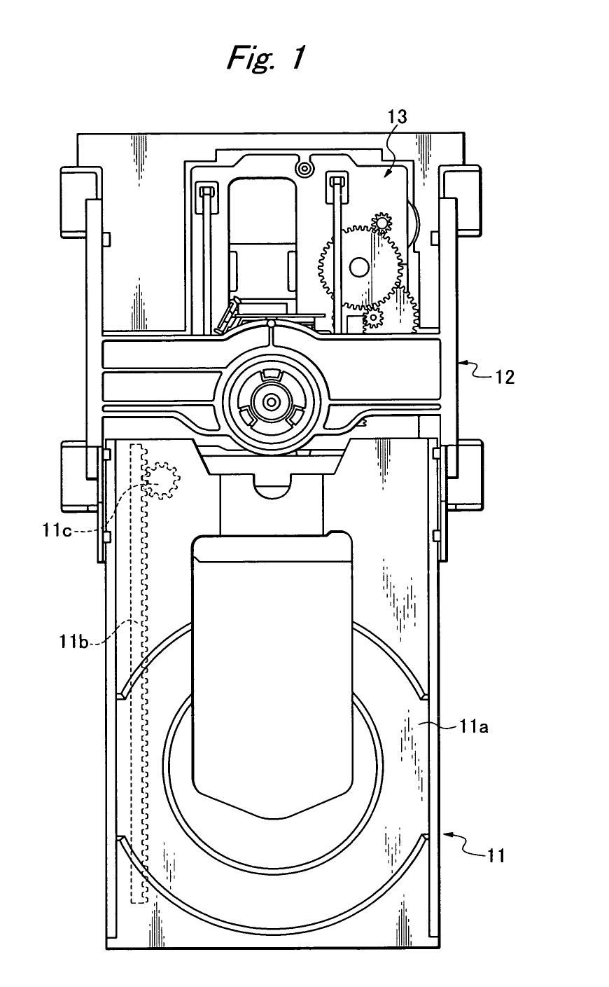

A disk drive provided with a tray according to an embodiment of the invention comprises a tray 11, a drive body chassis 12 and a traverse unit 13, as shown in FIG. 1. On an upper surface of the tray 11, a circular concave 11a is formed on which a disk is set. A gear 11c driven to rotate by means of a motor (not shown) is arranged to engage with a rack 11b so that the tray 11 can slide back and forth between a place for changing the disk and a place for housing the disk.

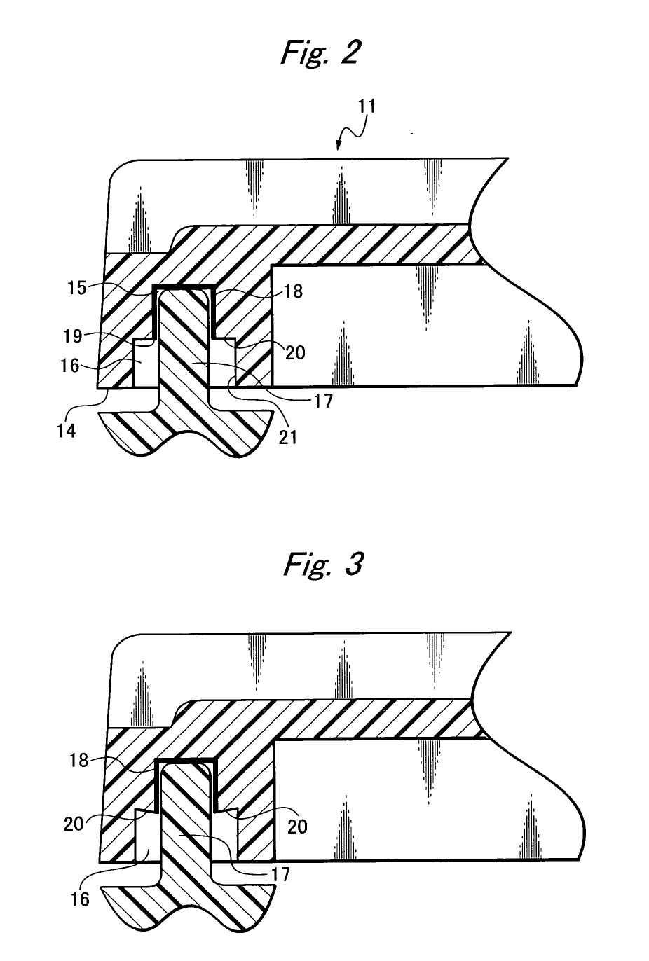

A guide groove 15 is formed on a bottom of a wide opening groove 16 on the both sides of a back surface of the tray 11, as shown in FIG. 2. A boss 17 protruded from a drive body chassis 12 is fitted to the guide groove 15 with play so as to be freely slidable. The length of a protruded part of the boss 17 is a little longer than that of the conventional case since the guide groove 15 is provided on the bottom of the wide opening groove 16.

Grease 18 is applied to the guide groove 15 to reduce frictional drag between the guide groove 15 and the boss 17. The grease 18 is applied only on bottom and side surfaces of the guide groove 15. The wide opening groove 16 is provided between the grease application surfaces and the back surface 14 of the tray. This makes a possibility that the grease 18 adhered to a lower edge 19 of the side surface of the guide groove 15 flows from a bottom surface 20 of the wide opening groove 16 to a side surface 21 thereof is very small. This is because the bottom surface 20 of the wide opening groove 16 is a horizontal surface as shown in FIG. 2 and the grease 18 is difficult to flow on the horizontal bottom surface 20. Accordingly, the grease 18 applied to the guide groove 15 does not flow to reach the back surface 14 of the tray.

The bottom surface 20 of the wide opening groove 16 may be an inclined surface, which is a little higher on the both sides as shown in FIG. 3, instead of a horizontal surface. This makes the flow of the grease on the bottom surface 20 more difficult.

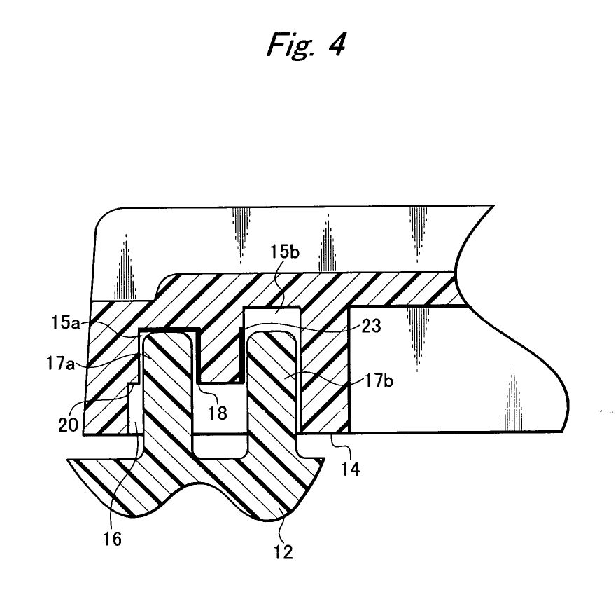

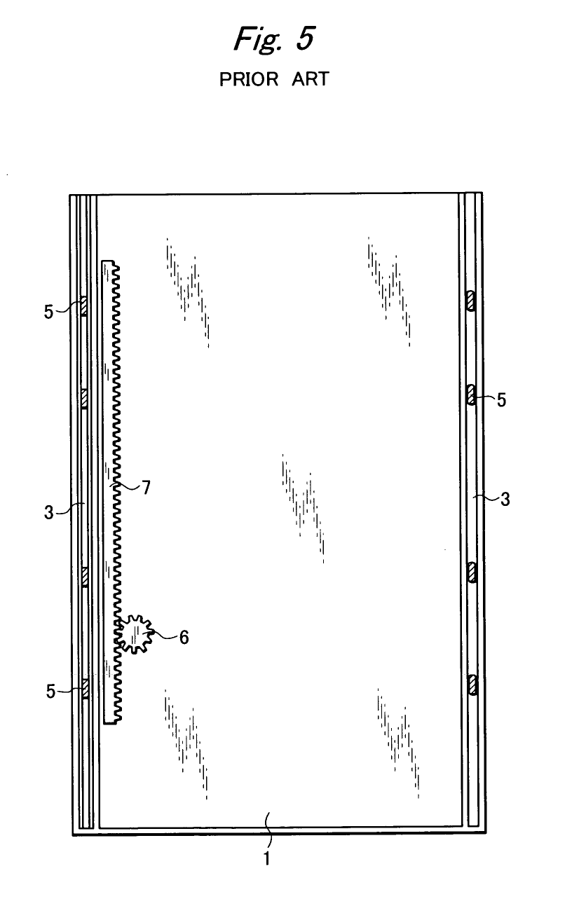

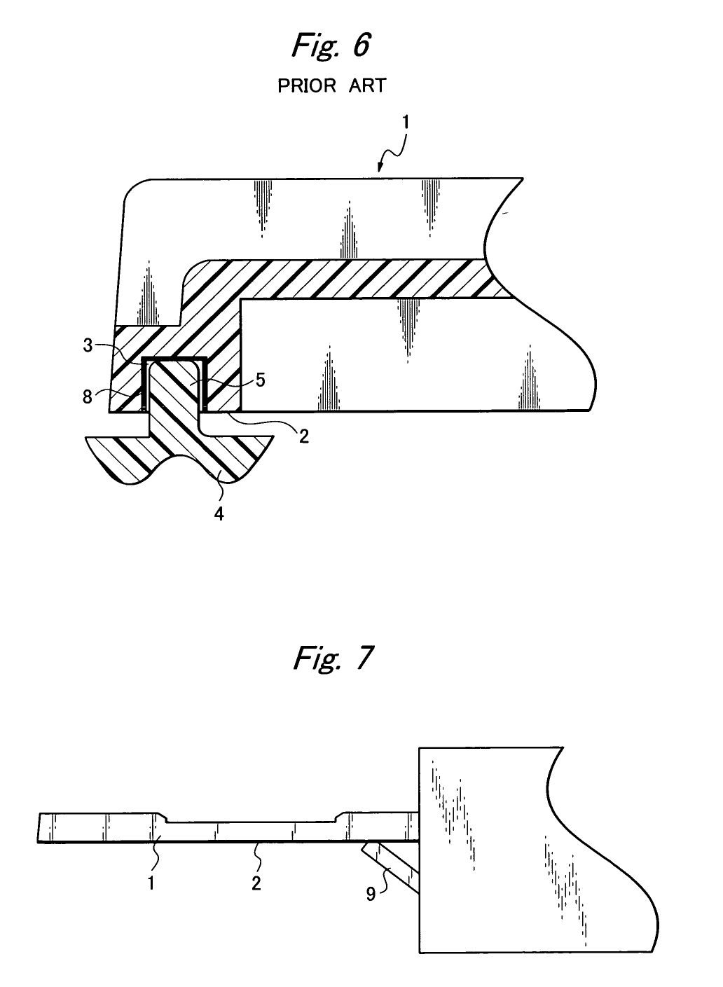

FIG. 4 shows another embodiment of the invention, in which a pair of bosses 17a and 17b rises from the drive body chassis 12 on one side thereof with a predetermined space. On the back surface of the tray 11, formed are guide grooves 15a and 15b corresponding to the both bosses 17a and 17b on the bottom of the wide opening groove 16. A guide piece 22 is formed between the both guide grooves 15a and 15b. One boss 17a is fitted to the guide groove 15a with play while the other boss 17b is fitted to the guide groove 15b with play, so that the guide piece 22 is sandwiched between the both bosses 17a and 17b. The guide groove 15b is formed deeper than the guide groove 15a. A predetermined space exists between a top end of the boss 17b and a bottom surface of the guide groove 15b.

The grease 18 is applied to an upper surface and one side surface of the guide groove 15a, the surfaces are black-painted, while it is only applied to a black-painted side surface of the guide groove 15b. That is to say, the grease 18 is applied to surfaces on and with which the bosses 17a and 17b slide and contact. Accordingly, the grease 18 applied to the side surfaces of the guide grooves 15a and 15b only adheres to the drive body chassis 12 even in the case of flowing down, and therefore, the grease is not likely to adhere to a user's hand.

What is claimed is:

1. A disk drive comprising a tray for preventing adhesion of grease which sets and carries in and out a disk, wherein wide opening grooves are respectively formed on both sides of a back surface of the tray, a guide groove to which at least a boss protruded from a drive body chassis is fitted with play so as to be freely slidable is formed on a bottom part of the wide opening groove and grease is applied to the guide groove.

2. A disk drive according to claim 1, wherein a bottom surface of the wide opening groove is a horizontal surface.

3. A disk drive according to claim 1, wherein a bottom surface of the wide opening groove is an inclined surface whose both sides are higher.

4. A disk drive according to claim 1, wherein the boss protruded from the drive body chassis forms a pair projected with a predetermined space, the two guide grooves are formed to which the pair of bosses are respectively fitted with play and a guide piece is formed between the both guide grooves so as to be sandwiched between the both bosses.

5. A disk drive according to claim 4, wherein one of the pair of guide grooves is formed deeper than the other so that only a top end of one boss would be freely slidable on and contact with a shallower bottom surface of the guide groove and grease is not applied to a deeper bottom surface of the guide groove.
